(19) United States
(12) Patent Application Publication
(10) Pub. No.: US 2014/0229715 A1
(43) Pub. Date: Aug. 14, 2014

(54) APPARATUS AND METHOD FOR PROVIDING EVENTING IP AND SOURCE DATA ADDRESS IN A STATISTICAL SAMPLING INFRASTRUCTURE

(71) Applicants: Laura A. Knauth, Portland, OR (US); Peggy J. Irelan, Chandler, AZ (US)

(72) Inventors: Laura A. Knauth, Portland, OR (US); Peggy J. Irelan, Chandler, AZ (US)

(21) Appl. No.: 13/976,613

(22) PCT Filed: Dec. 29, 2011
(86) PCT No.: PCT/US11/67822

§ 371 Date: Jun. 27, 2013

(51) Int. Cl. G06F 9/30

(52) U.S. Cl. CPC G06F 9/3001; G06F 9/30043
USPC 712/221

(57) ABSTRACT

A processor includes a core that includes an execution engine unit for executing instructions, a controller, and a storage having stored thereon a statistical sampling record, in which in response to occurrence of a hardware event caused by executing an instruction, the controller is configured to: (1) determine an instruction pointer (IP) pointed to the instruction that actually caused the hardware event; and (2) write the IP as an Eventing IP in a field of the statistical sampling record. The controller is further configured to determine a data address at which a load/store operation associated with the instruction accesses data, and write the data address to a data address field of the statistical sampling record.

### FIELD OF THE INVENTION

The present disclosure pertains to apparatus and methods for enhancing processor performance, in particular, to apparatus and methods for reliably identifying an instruction pointer (IP) pointing to the actual instruction that causes hardware events such as data cache misses in the context of statistical sampling such as precise event based sampling (PEBS).

### BACKGROUND OF THE INVENTION

Computer systems may include one or more processors each of which may further include one or more cores that execute instructions through instruction pipelines. To achieve high performance of instruction execution through instruction pipelines, a processor may include digital circuits that executes instructions in anticipation of the occurrences of certain conditions. For example, a branch predictor is a digital circuit that is commonly used to predict which way a branch code (e.g., an if-then-else structure) may proceed before it is known for sure. If one branch is predicted more likely to occur, a core of the processor may fetch and execute instructions for that branch before the branching condition actually occurs. The results of these speculatively executed instructions may be stored in a storage device such as cache memory. Later, if the branching condition indeed occurs, the pre-fetched and executed instructions may be retired, and the stored results may be used. However, if the branching condition does not occur, the stored instructions are discarded, and the instruction pipeline starts over with the correct branch, incurring a penalty of delay.

The time wasted for branch misprediction may correspond to the number of stages that have been pre-fetched and executed. Since instruction pipelines in modern processors may include a significant number of stages, the time wasted for branch misprediction may include many clock cycles. Since branch misprediction, when it occurs frequently, may cause significant bottlenecks (or hotspots) to the performance of the processor, it is advantageous to monitor where the mispredictions occur and when they occur so that a user of the processor may debug and optimize the software performance accordingly.

To this end, currently, a processor may be configured with a performance monitor unit (PMU) that monitors and records the misses. The PMU may be at the micro-architecture level and monitor for hardware events pertaining to processor stalls, branch prediction, and data/code alignment, and “glass jaws” (i.e., potentially fatal defects). The collected information may be available through an operating system or an application to the user for debugging and optimizing software performance. The user may need, from PMU, information about where the most inefficient spots are, or where the processor spends the most time doing the least amount of work, or those hotspots.

The identification of hotspots may be achieved by PMU profiling the time spent and the work carried out. One profiling mechanism, called Precise Event Base Sampling (PEBS), ties hardware events to source code or instruction pointer (IP) that causes the misses. Current art requires extensive searches in post-processing of PEBS record fields to reconstruct the IP of the instruction that triggers a hardware event and the type of the event. Unfortunately, this post-processing process is not reliable.

### DESCRIPTION OF THE FIGURES

FIG. 1 illustrates a processor core according to an exemplary embodiment of the present invention.

FIG. 2 illustrates a debug store (DS) area according to an exemplary embodiment of the present invention.

FIG. 3 illustrates a 64-bit PEBS data record according to an exemplary embodiment of the present invention.

FIG. 4 illustrates a controller configured to determine Eventing IP according to an exemplary embodiment of the present invention.

FIG. 5 is a block diagram of a system according to an exemplary embodiment of the present invention.

### DETAILED DESCRIPTION

There is a need to more accurately capture the IP of the instruction for the hardware event that the processor is configured to statistically to sample so as to improve the effectiveness of PEBS at pinpointing hotspots or areas of contention.

Although branch mispredition is one of the events that embodiments of the present invention may address, embodiments of the present invention are not limited to branch mispredition events. Embodiments of the present invention may be similarly applicable to other types of hardware events.

Embodiments of the present invention may include a performance monitor unit (PMU) that is configured to capture the actual IP of the instruction that causes the PEBS event (also called “eventing IP”) rather than the IP after the eventing IP. Embodiments of the present invention may further include a storage stored thereon a PEBS record that may include a first field for storing the eventing IP and a second field for storing a data address at which a load and/or store operation associated with the instruction accesses data. Compared to current approach, the present invention has the advantage of eliminating the need for reconstructing the eventing IP later and thus improving the success rate of data sampling.

Embodiments of the present invention may include a processor with one or more cores that each includes an execution engine unit for executing instructions, a controller, and a storage having stored thereon a statistical sampling record, in which in response to occurrence of a hardware event caused by executing an instruction, the controller may be configured to: (1) determine an instruction pointer (IP) pointed to the instruction that actually caused the hardware event; and (2) write the IP as an Eventing IP in a field of the statistical sampling record. The controller may be further configured to determine a data address at which a load/store operation associated with the instruction accesses data, and write the data address to a data address field of the statistical sampling record.

Embodiments of the present invention may include a controller embedded in a core of a processor that includes an execution engine unit for executing instructions. The controller may access a storage device having stored thereon a statistical sampling record that includes a field for, in response to occurrence of a hardware event caused by executing an instruction, storing, as an Eventing IP, an instruction pointer (IP) pointed to the instruction that actually caused the hardware event.

Embodiments of the present invention may include a method for managing a statistical sampling record of a processor. The method may include, in response to occurrence of a hardware event caused by executing an instruction, determining, as an Eventing IP, an instruction pointer (IP) pointed to the instruction that actually caused the hardware event, and writing the Eventing IP in a field of the statistical sampling record.

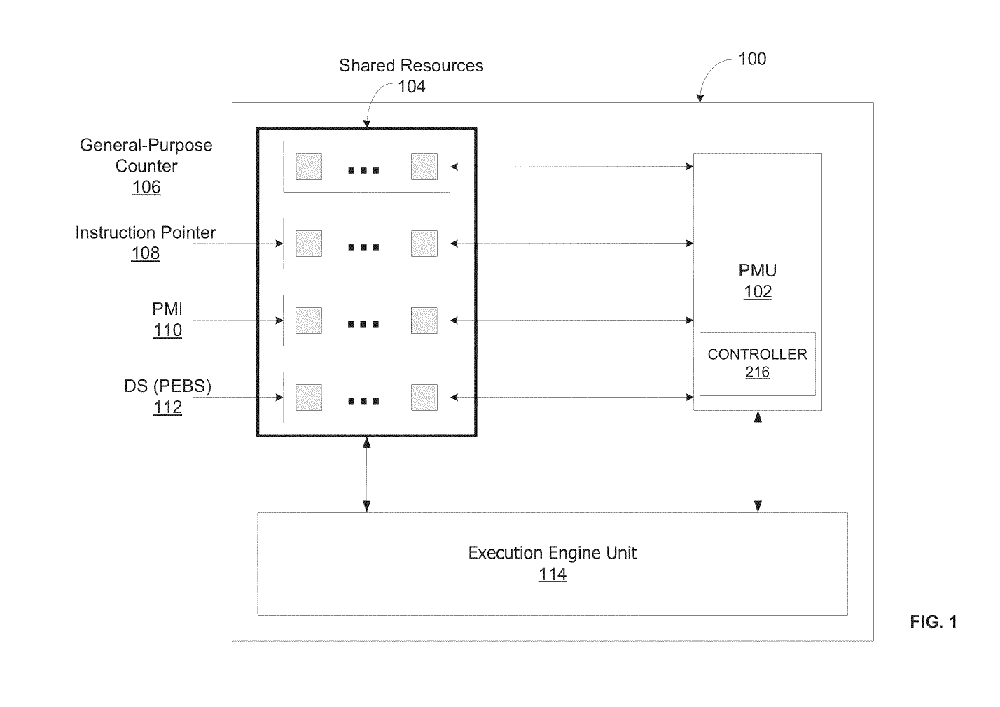

FIG. 1 illustrates a processor core 100 that includes reliable performance monitoring according to an exemplary embodiment of the present invention. The processor core 100 may be one of many cores embedded in a many-core processor. Referring to FIG. 1, the core 100 may include an execution engine unit 114, a performance monitor unit (PMU) 102, and a shared resources 104 that includes resources such as counters for the PMU 102. The execution engine unit 114, the PMU 102, and the shared resources 104 may be communicatively connected with each other. The execution engine unit 114 may include an instruction pipeline (not shown) for executing instructions. The PMU 102 may include a hardware controller 116 configured with microcodes for monitoring and recording hardware events such as branch mispredictions that occur during instruction execution by the execution engine unit 114. The PMU 102 may be a ring 0 programmable measurement hardware including a collection of registers to serve as an interface between the execution engine unit 114 and the shared resources 104.

The shared resources 104 may include a memory storage (such as cache memory or registers) that is directly accessible by the execution engine unit 114 and the PMU 102, and also by applications. In one embodiment, the shared resources 104 may be dedicated to the core 100. In another embodiment, the shared resources 104 may be shared by a number of cores within the many-core processor. The shared resources may be further partitioned into a number of segments including general purpose counters 106, instruction pointers 108, and debug store 112. The shared resources may also include performance monitoring interrupts (PMI) 210 signals. Each of the general purpose counters 106 may be used to measure a specific hardware event. In one embodiment, the general purpose counters 106 may correspond to fifty or more hardware events including “precise branch instruction retired by type” and “mispredicted near retired calls.” The instruction pointer 108 (also known as program counter) may include registers that indicate where the execution engine unit 114 is at the execution of instruction sequence or the instruction address. The PMI 110 may provide interrupts, at user's request, in response to a counter overflow. Thus, the user may either elect to execute a program to store a statistical sampling record, such as a PEBS record, or generate a PMI 110 to halt the processor in the event of the counter overflow. The debug store 112 may store data relating to program debug. A portion of the debug store 112 may be configured to store information relating to the statistical sampling record such as PEBS record.

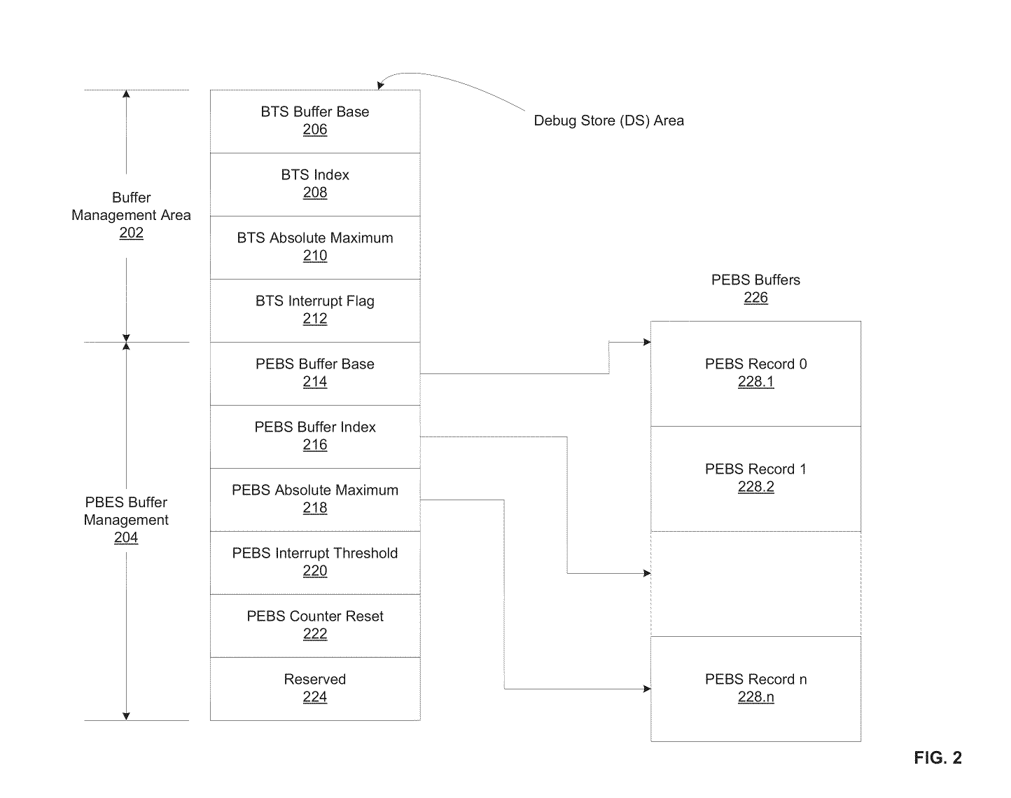

FIG. 2 illustrates a detailed construction of a debug store (“DS”) area according to an exemplary embodiment of the present invention. In one exemplary embodiment, the DS area may be partitioned into three segments including a branch management area 202, a branch trace store (BTS) buffer area (not shown), and a PEBS buffer management area 204 for managing PEBS records. The DS area may have an address (DS_AREA) at which the DS area may be accessed. In one exemplary embodiment, the address may be a linear address at which the DS area may be directly accessed. In another exemplary embodiment, the address may be an effective address or a physical address. Additionally, each of the branch management area 202, branch tree store buffer are, and PEBS buffer management area 204 may also have a respective address at which any one of them may be accessed. The branch management area 202 may be configured to store information relating to the branch traces stored in the branch trace store buffers. The branch traces may be generated by the execution engine unit 114 to track each branching situation during executing instructions. In this regard, the branch management area 202 may include registers for storing information relating to branch trace store. In one exemplary embodiment, the branch management area 202 may include a field 206 for storing BTS buffer base address, a field 208 for storing an BTS index, a field 210 for storing a BTS absolute maximum address, and a field 212 for storing a BTS interrupt threshold. The BTS buffer base address may be directed at the address of the first byte of BTS buffer area. The BTS index may be directed at the address of the first byte of the next BTS buffer to be written to. The BTS absolute maximum address may provide the upper limit of addresses for the BTS buffer area or the address to the next byte past the end of the BTS buffer area. The BTS interrupt flag, when set, may cause the BTS to facilitate the generation of an interrupt in response to a BTS buffer overflow.

The PEBS buffer management area 204 may be configured to store a field 214 for storing the PEBS buffer base, a field 216 for storing the PEBS buffer index, a field 218 for storing the PEBS absolute maximum address, a field 220 for storing the PEBS interrupt threshold value, a field 222 for storing the PEBS counter reset, and a field 224 as reserved. The PEBS buffer base may be directed at the address of the first byte of PEBS buffers 226 which may be part of the DS area and include a plurality of PEBS records 328.1, 328.2, . . . , 328.n. The PEBS index, which may be referenced by a last branch record register, may be directed at the address of the first byte of the next PEBS record to be written to. The PEBS index may be initialized at the PEBS buffer base. The PEBS absolute maximum address may be directed at the next byte past the end of the PEBS buffer. The PEBS interrupt threshold may be used to generate an PEBS interrupt. The PEBS index may point to an offset that is a multiple of the PEBS record size from the PEBS buffer base and to be several records shorter than the PEBS absolute maximum. The PEBS counter resets may include full width counter values to which PEBS counters are reset after architectural state information about the core has been sampled following a PEBS counter overflow caused by a hardware event. In one embodiment, multiple PEBS records may be stored in the PEBS buffer area. The PEBS interrupt may be used to halt the processor when the PEBS buffer is about to fill up so that any new records may not be dropped. In another embodiment, a PEBS interrupt may be generated after writing each PEBS record so that the written PEBS record may be read out.

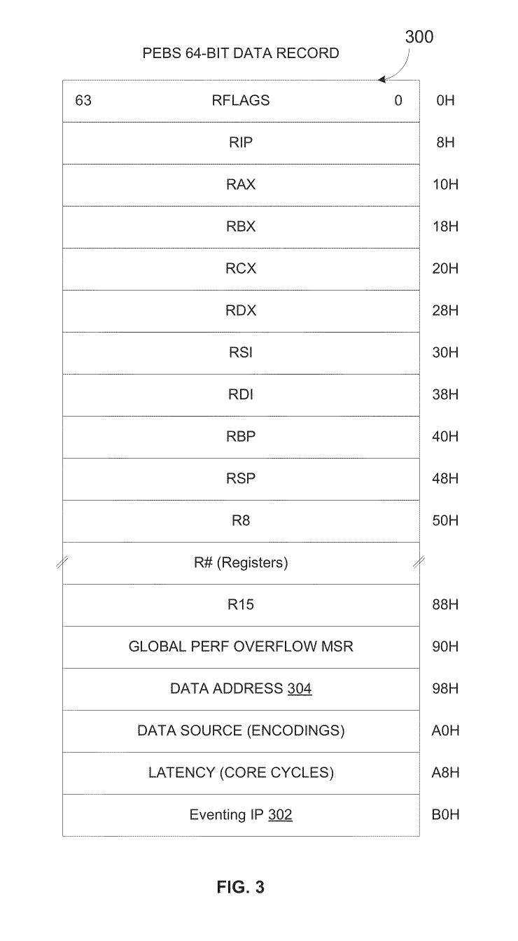

Embodiments of the present invention may include a plurality of PEBS records stored in the PEBS buffers 226 and managed through fields contained in the PEBS buffer management area 204. Each of the PEBS records may correspond to a specific hardware event. FIG. 3 illustrates a 64-bit PEBS data record according to an exemplary embodiment of the present invention. Referring to FIG. 3, the PEBS record may include a plurality of registers each of which is 64-bit wide. These registers may contain debug information. For example, RAX and RBX may be related to first and second floating point arguments, and RCX and RDX may be related to first and second integer arguments. Embodiments of the present invention may include a new Eventing IP register which is enabled and records the actual IP of the instruction or microcode (ucode) that caused the PEBS event (e.g., a branch misprediction) rather than the IP of the instruction after the instruction that incurred the PEBS event. The Eventing IP register may be at a suitable address such as at address B0H. In this way, programs that is designed to attempt to reconstruct the missing PEBS IP are no longer needed.

Additionally, embodiments of the present invention may offer capability for obtaining data address to profile data memory address referenced by the instruction or ucode that caused the hardware event. In one embodiment, the PEBS data record 300 may include a register 304 for storing the direct data address, which may provide additional information about the sampled instruction and help programmers improve data structure layout, memory page handling, eliminating remote node references, and identifying cache-line condition conflicts. Instructions that have load or store operations may access memory at a particular address. Provision of this address in the PEBS record may allow a user to determine which instructions (determined by Eventing IP field) are accessing a particular line of the memory. Thus, if the PMU may monitor time-consuming cache miss events such as last level cache and determine which particular data address appears in the PEBS record repeatedly. Based on this information, a user may determine that there is a contention for that address and rework the program to resolve the contention.

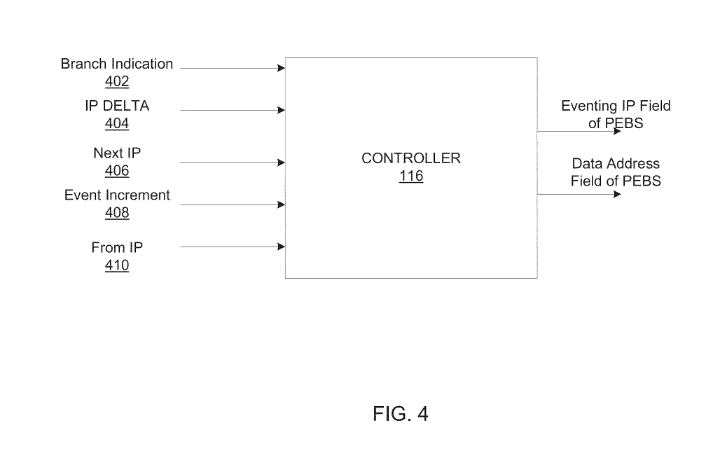

In one embodiment, the controller 116 as shown in FIG. 1 may be configured with executable microcode that, when executed, may determine the Eventing IP using the method as listed in the pseudo codes below. FIG. 4 illustrates a controller configured to determine Eventing IP according to an exemplary embodiment of the present invention. Controller 116 may be part of the digital circuitry within the PMU 102. Alternatively, controller 116 may be a digital circuit separate from the PMU 102 but within the processor core 100. The controller may, through hardware connections, receive signal inputs of macro branch indication 402, IP offset (“IP Delta”) 404, next IP 406, Event increment 408, and From IP 410. In response to the occurrence of a hardware event such as a branch misprediction, the branch indication 402 may be transmitted to a first input of the controller 116. The branch indication 402 may include a signal to indicate whether or not a branch has occurred (or “taken”). Since the instructions may have variable code lengths, the length of each instruction (IP Delta 404) as the instruction is retired may be transmitted to a second input of the controller. Further, a third input of the controller 116 may receive the next IP address (Next IP 406) which may indicate the address of the next instruction to be executed by the processor. A fourth input of the controller 116 may receive event increment 408 which indicates IP address of next event. A fifth input of the controller 116 may receive a From IP 410 input which may indicate the address from which a macro branch occurs. The From IP 410 may be read from as an internal state of the processor. Embodiments of the present invention may include a method as described in the pseudo codes below.

if (Event Overflow) {

Eventing IP = if (macro branch not taken)

If (fault)

Fault_IP;

else if (not fault)

Next_IP − IP_Delta;

else if (macro branch taken)

load Branch_From IP uarch register value;

write Eventing IP to the Eventing IP field of PEBS record;
if (load or store) {

retrieve data address;
write data address to Data Address field of PEBS record;
}

}

Thus, the controller 116 may be configured to first determine whether a hardware event has occurred based on a flag indicating event overflow. The event may include a branch misprediction. However, the type of events is not limited to the branch misprediction event. If it is determined that a hardware event has occurred, embodiments of the present invention may further include steps to determine the Eventing IP (or the IP of the instruction that actually caused the event) and data address that associated with the Eventing IP. To determine the Eventing IP, the controller 116 may first determine whether a macro branch has already occurred (or “taken”) based on the branch prediction. If the macro branch has not taken, the controller 116 may further determine whether the instruction causes a fault or a special condition that may require further to clean up. If the instruction causes the fault (the IP does not move), the Eventing IP may be assigned with the faulting IP of the instruction that causes the fault (Fault_IP). However, if the instruction did not cause a fault or executed successfully (the IP moved), the Eventing IP is assigned with next IP-IP Delta, so that the Eventing IP points at the current instruction just executed (or retired). Alternatively, if the event that macro branch has taken based on the branch prediction, the Eventing IP of the current instruction may not be related to the next IP. For this case, the controller 116 may be configured to read from a “From IP” register which indicate the address from which a macro branch occurs. The Eventing IP may be assigned to the “From IP” address or the address prior to the macro branch. After the Eventing IP is determined, controller 116 may be configured to write the determined Eventing IP to the Eventing IP field of the PEBS record for the event so that the Eventing IP may be accessible by a user for debugging and optimizing applications.

The controller 116 may be further configured to retrieve data address in the event that the current instruction invoked load or store operations. To this end, if the current instruction invokes load or store operations, the controller 116 may be configured to retrieve the data addresses at which the load or store operations access data. Further, the controller 116 may be configured to write the Data Address field of the PEBS record to make it available for the user to debug and optimize programs.

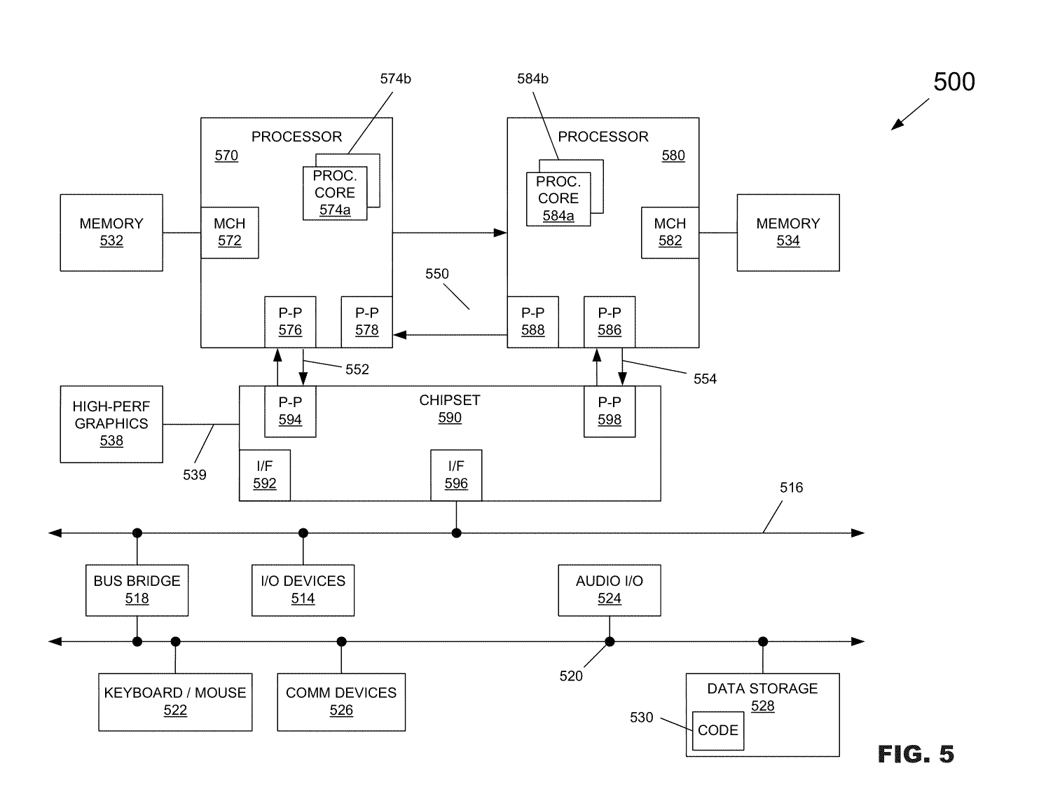

Embodiments may be implemented in many different system types. Referring now to FIG. 5, shown is a block diagram of a system in accordance with an embodiment of the present invention. As shown in FIG. 5, multiprocessor system 500 is a point-to-point interconnect system, and includes a first processor 570 and a second processor 580 coupled via a point-to-point interconnect 550. As shown in FIG. 5, each of processors 570 and 580 may be multi-core processors, including first and second processor cores (i.e., processor cores 574a and 574b and processor cores 584a and 584b), and potentially many more cores may be present in the processors. The processors each may perform variation-aware scheduling based on profile information obtained and stored in on-chip storage in accordance with an embodiment of the present invention to improve energy efficiency.

Still referring to FIG. 5, first processor 570 further includes a memory controller hub (MCH) 572 and point-to-point (P-P) interfaces 576 and 578. Similarly, second processor 580 includes a MCH 582 and P-P interfaces 586 and 588. As shown in FIG. 5, MCH's 572 and 582 couple the processors to respective memories, namely a memory 532 and a memory 534, which may be portions of main memory (e.g., a dynamic random access memory (DRAM)) locally attached to the respective processors, and which collectively may maintain a directory. First processor 570 and second processor 580 may be coupled to chipset 590 via P-P interconnects 552 and 554, respectively. As shown in FIG. 5, chipset 590 includes P-P interfaces 594 and 598.

Furthermore, chipset 590 includes an interface 592 to couple chipset 590 with a high performance graphics engine 538, by a P-P interconnect 539. In turn, chipset 590 may be coupled to a first bus 516 via an interface 596. As shown in FIG. 5, various input/output (I/O) devices 514 may be coupled to first bus 516, along with a bus bridge 518 which couples first bus 516 to a second bus 520. Various devices may be coupled to second bus 520 including, for example, a keyboard/mouse 522, communication devices 526 and a data storage unit 528 such as a disk drive or other mass storage device which may include code 530, in one embodiment. Further, an audio I/O 524 may be coupled to second bus 520.

Note that while shown in the embodiment of FIG. 5 as a multi-package system (with each package including a multi-core processor) coupled via point-to-point interconnects, the scope of the present invention is not so limited. In other embodiments, other interconnects such as a front side bus may couple together processors in a dual or multiprocessor system. Still further, understand that embodiments may further be used in uniprocessor systems, e.g., in a system having a processor with a single core or multiple cores.

Embodiments may be implemented in code and may be stored on a storage medium having stored thereon instructions which can be used to program a system to perform the instructions. The storage medium may include, but is not limited to, any type of disk including floppy disks, optical disks, optical disks, solid state drives (SSDs), compact disk read-only memories (CD-ROMs), compact disk rewritables (CD-RWs), and magneto-optical disks, semiconductor devices such as read-only memories (ROMs), random access memories (RAMs) such as dynamic random access memories (DRAMs), static random access memories (SRAMs), erasable programmable read-only memories (EPROMs), flash memories, electrically erasable programmable read-only memories (EEPROMs), magnetic or optical cards, or any other type of media suitable for storing electronic instructions.

While the present invention has been described with respect to a limited number of embodiments, those skilled in the art will appreciate numerous modifications and variations therefrom. It is intended that the appended claims cover all such modifications and variations as fall within the true spirit and scope of this present invention.

What is claimed is:

1. A processor, comprising:
a core that includes:
an execution engine unit for executing instructions;
a controller; and
a storage having stored thereon a statistical sampling record,
wherein in response to occurrence of a hardware event caused by executing an instruction, the controller is configured to:
determine an instruction pointer (IP) pointed to the instruction that actually caused the hardware event; and
write the IP as an Eventing IP in a field of the statistical sampling record.

2. The processor of claim 1, wherein the controller is further configured to:
determine a data address at which a load/store operation associated with the instruction accesses data; and
write the data address to a data address field of the statistical sampling record.

3. The processor of claim 2, wherein in response to the occurrence of the hardware event, the controller is configured to:
determine if a macro branch has occurred;
if the macro branch did not occur, determine if the instruction causes a fault;
if the instruction causes the fault, assign the Eventing IP with a fault IP; and
else if the instruction does not cause the fault, assign the Eventing IP with a next IP subtracting a code length of the instruction;
else if the macro branch occurred, assign the Eventing IP with an address from which the macro branch occurred;
write the Eventing IP to an Eventing IP field of the statistical sampling record;
determine if the instruction is associated with load/store operation; and
if it is:
retrieve data address at which the load/store operation accesses data; and
write the data address to a data address field of the statistical sampling record.

4. The processor of claim 1, wherein the hardware event is a branch misprediction event.

5. The processor of claim 1, wherein the statistical sampling record is a precise event based sampling (PEBS) record.

6. The processor of claim 5, wherein the PEBS record is accessible by a user for debugging and optimizing programs.

7. A controller embedded in a core of a processor that includes an execution engine unit for executing instructions, the controller being configured to access a storage having stored thereon a statistical sampling record that includes a field for, in response to occurrence of a hardware event caused by executing an instruction, storing, as an Eventing IP, an instruction pointer (IP) pointed to the instruction that actually caused the hardware event.

8. The controller of claim 7, wherein in response to the occurrence of the hardware event caused by executing the instruction, the controller is configured to:
determine the IP; and
write the IP in a field of the statistical sampling record.

9. The controller of claim 8, wherein the controller is further configured to:
determine a data address at which a load/store operation associated with the instruction accesses data; and
write the data address to a data address field of the statistical sampling record.

10. The controller of claim 9, wherein in response to the occurrence of the hardware event, the controller is configured to:
determine if a macro branch has occurred;
if the macro branch did not occur, determine if the instruction causes a fault;
if the instruction causes the fault, assign the Eventing IP with a fault IP; and
else if the instruction does not cause the fault, assign the Eventing IP with a next IP subtracting a code length of the instruction;
else if the macro branch occurred, assign the Eventing IP with an address from which the macro branch occurred;
write the Eventing IP to an Eventing IP field of the statistical sampling record;
determine if the instruction is associated with load/store operation; and
if it is:
retrieve data address at which the load/store operation accesses data; and
write the data address to a data address field of the statistical sampling record.

11. The controller of claim 7, wherein the hardware event is a branch misprediction event.

12. The controller of claim 7, wherein the statistical sampling record is a precise event based sampling (PEBS) record.

13. A method for managing a statistical sampling record of a processor, comprising:
in response to occurrence of a hardware event caused by executing an instruction, determining, by a controller, as an Eventing IP, an instruction pointer (IP) pointed to the instruction that actually caused the hardware event; and
writing, by the controller, the Eventing IP in a field of the statistical sampling record.

14. The method of claim 13, further comprising:
determining a data address at which a load/store operation associated with the instruction accesses data; and
writing the data address to a data address field of the statistical sampling record.

15. The method of claim 14, wherein in response to the occurrence of the hardware event, the controller is configured to:
determine if a macro branch has occurred;
if the macro branch did not occur, determine if the instruction causes a fault;
if the instruction causes the fault, assign the Eventing IP with a fault IP; and
else if the instruction does not cause the fault, assign the Eventing IP with a next IP subtracting a code length of the instruction;
else if the macro branch occurred, assign the Eventing IP with an address from which the macro branch occurred;
write the Eventing IP to an Eventing IP field of the statistical sampling record;
determine if the instruction is associated with load/store operation; and
if it is:
retrieve data address at which the load/store operation accesses data; and
write the data address to a data address field of the statistical sampling record.

16. The method of claim 13, wherein the hardware event is a branch misprediction event.

17. The method of claim 16, wherein the statistical sampling record is a precise event based sampling (PEBS) record.

18. A system comprising:
a memory for storing instructions;
a processor including a core that includes:
an execution engine unit for executing the instructions;
a controller; and
a storage having stored thereon a statistical sampling record,
wherein in response to occurrence of a hardware event caused by executing an instruction, the controller is configured to:
determine an instruction pointer (IP) pointed to the instruction that actually caused the hardware event; and
write the IP as an Eventing IP in a field of the statistical sampling record.

19. The system of claim 18, wherein the controller is further configured to:
determine a data address at which a load/store operation associated with the instruction accesses data; and
write the data address to a data address field of the statistical sampling record.

20. The system of claim 18, wherein in response to the occurrence of the hardware event, the controller is configured to:
determine if a macro branch has occurred;
if the macro branch did not occur, determine if the instruction causes a fault;
if the instruction causes the fault, assign the Eventing IP with a fault IP; and
else if the instruction does not cause the fault, assign the Eventing IP with a next IP subtracting a code length of the instruction;
else if the macro branch occurred, assign the Eventing IP with an address from which the macro branch occurred;
write the Eventing IP to an Eventing IP field of the statistical sampling record;
determine if the instruction is associated with load/store operation; and
if it is:
retrieve data address at which the load/store operation accesses data; and
write the data address to a data address field of the statistical sampling record.
